(19) United States
(12) Patent Application Publication
(10) Pub. No.: US 2011/0069871 A1
(43) Pub. Date: Mar. 24, 2011

(54) INDOOR ENERGY-SAVING SYSTEM

(75) Inventor: Chia-Chun TSOU, Taipei County (TW)

(73) Assignee: UTECHZONE CO., LTD., TAIPEI COUNTY (TW)

(21) Appl. No.: 12/888,067

(22) Filed: Sep. 22, 2010

(30) Foreign Application Priority Data
Sep. 23, 2009 (TW) 098132029

(51) Int. Cl. G06K 9/00

(52) U.S. Cl. 382/107

(57) ABSTRACT

An indoor energy-saving system includes an image capture device, a motion detection module and a switch module. The image capture device is provided for capturing image data from a monitored area of a room. The motion detection module is coupled to the image capture device for analyzing a human motion occurred in the monitored area from the captured image data. In addition, the switch module is coupled to the motion detection module for controlling transmission of electric power to a load in the room according to an analyzed result of the motion detection module.

### BACKGROUND OF INVENTION

1. Field of Invention

The present invention relates generally to an energy-saving system, and more particularly to an energy-saving system utilizing motion detection technologies for power management of an illuminating device and/or other electrical appliances.

2. Related Prior Art

There are many situations where lighting needs to be controlled in an automatic manner for energy saving. For this, a number of light management systems are known. One type of the light management system utilizes a motion detector or sensor. For example, a passive infrared (PIR) motion sensing is commonly used in the light management system for automatic illumination of room lighting when a person enters a room. In such systems, room lights are turned off, turned on and/or are dimmed according to a detected level of motion within the room.

### SUMMARY OF INVENTION

Broadly stated, the present invention is directed to an indoor energy-saving system, comprising an image capture device, a motion detection module and a switch module. The image capture device is configured for capturing image data from a monitored area of a room. The motion detection module is coupled to the image capture device for analyzing a human motion occurred in the monitored area according to the captured image data. The switch module is coupled to the motion detection module for controlling transmission of electric power to a load in the room according to an analyzed result of the motion detection module.

Specifically, the motion detection module can recognize a movable object from a static background according to the captured image data so as to identify whether the movable object is a human being or not and keep tracking the human motion. The switch module has a power control interface that allows a user to set up power conditions for a variety of appliances.

Preferably, the switch module is provided with a light source for illumination of the monitored area so as to maintain enough lighting for image capturing.

The construction of energy-saving system as described above is thus far largely conventional. According to the present invention, this configuration utilizes motion detection and track technologies to detect human motion for determining whether powers to the related electric appliances or not and thereby automatically reducing energy consumption.

Further features and advantages of the present invention will be appreciated by review of the following detailed description of the invention.

### BRIEF DESCRIPTION OF DRAWING

The invention is illustrated by the accompanying drawing in which corresponding parts are identified by the same numerals and in which:

FIG. 1 is a block diagram of an energy saving system according to the preferred embodiment of the present invention.

### DETAILED DESCRIPTION OF EMBODIMENTS

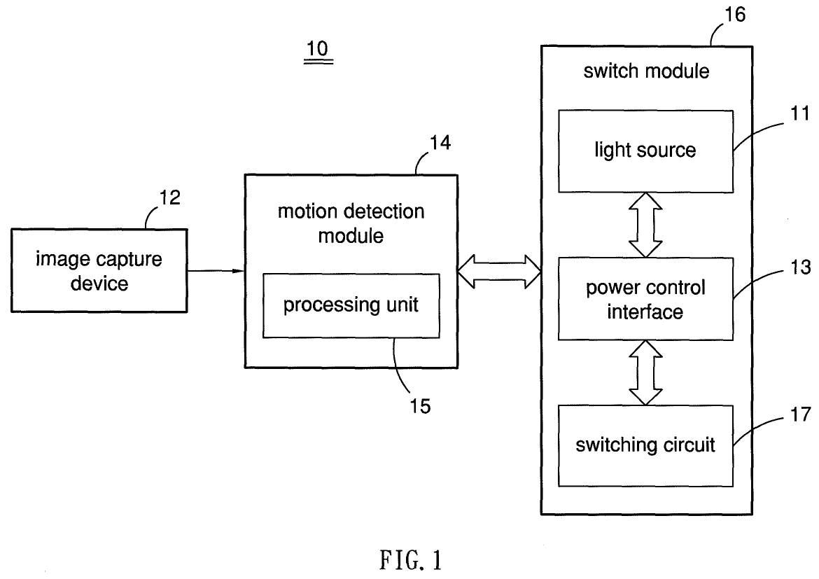

Referring now to FIG. 1 of the drawing, an energy saving system 10 in accordance with the preferred embodiment of the invention includes an image capture device 12, a motion detection module 14 coupled to the image capture device 12, and a switch module 16 coupled to the motion detection module 14.

In this embodiment, the image capture device 12, such as a CCD (Charged Coupled Device) camera, is configured for capturing image data from a monitored area of a room and transferring the captured image data to the motion detection module 14.

The motion detection module 14 is generally configured to analyze a human motion occurred in the monitored area according to the captured image data. Specifically, the motion detection module 14 includes a processing unit 15 (not shown) that is capable of recognizing a movable object from a static background according to the captured image data and then identify whether the movable object is a human being or not. Upon concluding that the movable object is truly a human being, the processing unit 15 of the motion detection module 14 further identifies detail features of that person. Afterward, the motion detection module 14 sends the analyzed result to the switch module 16.

The switch module 16 is provided to control transmission of electric power to a load, such as electrical appliances in the room, according to the analyzed result of the motion detection module 14. Specifically, the switch module 16 includes a light source 11, a power control interface 13 and a switching circuit 17. The light source 11 is provided for illumination of the monitored area to maintain enough lighting when the light is too dim, such as at night, for the image capture device 12 to capture enough-quality image data for further recognition by the motion detection module 14. The switching circuit 17 is provided to connect a power source with the electric appliances in the room.

The power control interface 13, coupled with the switching circuit 17, is provided to allow a user to set up some power conditions for those electric appliances. Once the conditions have been set up, the motion detection module 14 cooperates with the switch module 16 to carry out the power control over those related appliances according to the user-set conditions.

In a practical manner, the motion detection module 14 detects activities of the people in the room and determines how many people are there in the room and what specific locations are those people stay at? If the process unit 15 of the motion detection module 14 analyzes the captured image data from the image capture device 12 and concludes that the amount of the people in the room is increased or decreased, the processing unit 15 will drive the switching circuit 17 of the switch module 16 to adjust power supply for all the related appliances according to the use-set conditions. In this way, some or all of the appliances may be shut down or low-powered, as the user's desire, to make sure that the power goes exactly to the needed place and effectively used.

The construction of energy-saving system as described above is thus far largely conventional. According to the present invention, this configuration utilizes motion detection and track technologies to detect human motion for determining whether gives power to the related electric appliances or not and thereby automatically reducing energy consumption.

It will be appreciated that although a particular embodiment of the invention has been shown and described, modifications may be made. It is intended in the claims to cover such modifications which come within the spirit and scope of the invention.

The invention claimed is:

1. An energy-saving system comprising:
an image capture device for capturing image data from a monitored area of a room;
a motion detection module coupled to the image capture device for analyzing a human motion occurred in the monitored area according to the captured image data; and
a switch module coupled to the motion detection module for controlling transmission of electric power to at least one electric appliance according to an analyzed result of the motion detection module.

2. The energy-saving system of claim 1, wherein the motion detection module includes a processing unit configured to recognize a movable object from a static background according to the captured image data.

3. The energy-saving system of claim 2, wherein the processing unit is further configured to identify a feature of the object to identify whether the movable object is a human being.

4. The energy-saving system of claim 1, wherein the switch module includes a light source for illumination of the monitored area so as to maintain enough lighting for image capturing.

5. The energy-saving system of claim 1, wherein the switch module includes a power control interface that allows a user to set up a power condition for the electric appliance.

6. The energy-saving system of claim 1, wherein the switch module includes a switching circuit that is provided to connect a power source with the electric appliance.
